(19) United States
(12) Patent Application Publication
(10) Pub. No.: US 2014/0371047 A1
(43) Pub. Date: Dec. 18, 2014

(54) CENTRIFUGE ROTOR

(71) Applicant: L.U.M. GMBH, Berlin (DE)

(72) Inventors: Dietmar LERCHE, Berlin (DE); Uwe MERTENS, Berlin (DE); Uwe RIRTZ, Berlin (DE)

(21) Appl. No.: 13/920,615

(22) Filed: Jun. 18, 2013

(51) Int. Cl. G01N 1/00

(52) U.S. Cl. CPC G01N 1/00
USPC 494/10; 494/37

(57) ABSTRACT

A centrifuge rotor for measuring a characteristic of a sample subjected to centrifugation, the centrifuge rotor including: a rotor body; at least one sample holder for holding a sample; at least one on-board measurement device for measuring a characteristic of the sample held in the at least one sample holder during rotation of the rotor.

### FIELD

Disclosed is a centrifuge rotor suitable for use with a centrifuge machine. The centrifuge rotor can be used in conducting a measurement of a characteristic of at least one sample held by the centrifuge rotor.

### BACKGROUND INFORMATION

A centrifuge rotor can be used in a laboratory centrifuge to hold samples during centrifugation. During centrifugation, a centrifugal force is exerted upon the samples held in the centrifuge rotor due to the rotation of the centrifuge rotor. The resulting centrifuged samples can then be observed.

European Patent Document No. 0 602 587 A1 discloses a centrifuge rotor identification and instrument control system.

### SUMMARY

According to an exemplary aspect, disclosed is a centrifuge rotor for measuring a characteristic of a sample subjected to centrifugation, the centrifuge rotor comprising: a rotor body; at least one sample holder for holding a sample; at least one on-board measurement device for measuring a characteristic of the sample held in the at least one sample holder during rotation of the rotor.

According to an exemplary aspect, disclosed is a method of measuring a characteristic of a sample by centrifugation, the method comprising: providing an exemplary centrifuge rotor; attaching at least one sample to the centrifuge rotor with the at least one sample holder; rotating the centrifuge rotor; and conducting at least one measurement with the at least one measurement device during rotation of the rotor.

According to an exemplary aspect, disclosed is a centrifuge device for measuring a characteristic of a sample by centrifugation, the centrifuge device comprising: an exemplary centrifuge rotor; a housing; and a motor for rotating the centrifuge rotor.

### BRIEF DESCRIPTION OF THE DRAWINGS

FIG. 1 is a perspective top view of a centrifuge rotor, according to an exemplary aspect.

FIG. 2 is a perspective bottom view of a centrifuge rotor, according to an exemplary aspect.

FIG. 3 is a perspective bottom view of a centrifuge rotor, with a back plate removed, according to an exemplary aspect.

FIG. 4 is a perspective view of a back plate of a centrifuge rotor, according to an exemplary aspect.

FIG. 5 is a perspective view of a centrifuge rotor mounted to a centrifuge device, according to an exemplary aspect.

FIG. 6 is a diagram of an on-board system for storing and/or processing measurement data, according to an exemplary aspect.

FIG. 7 is a diagram of a sample having a first material and a second material adhered to each other, and a test stamp for measuring the strength of adhesion, according to an exemplary aspect.

### DETAILED DESCRIPTION

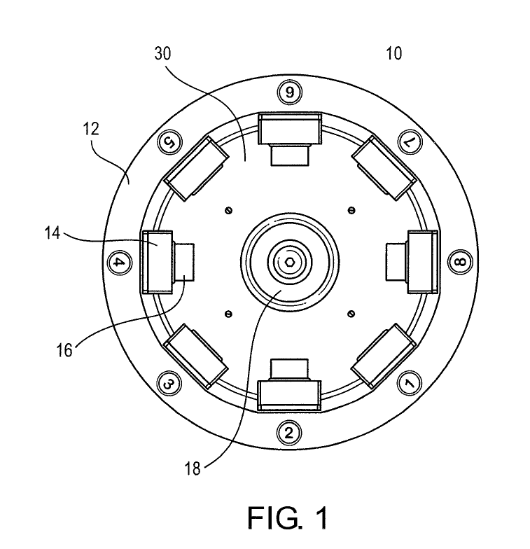

In an exemplary embodiment shown in FIG. 1, a centrifuge rotor 10 can include a rotor body 12. The centrifuge rotor 10 can also include at least one sample holder 14 and at least one measurement device (not shown). The sample holder 14 can accommodate at least one sample 16 to be measured. The rotor body 12 can include an attachment part 18 which enables the centrifuge rotor 10 to be securely attached to a centrifuge device (not shown). For example, the rotor body 12 can rotate about an axis of rotation, and the rotor body 12 can have an attachment part 18 for attaching the centrifuge rotor 10 to the centrifuge device, for example, at the axis of rotation of the centrifuge rotor 10.

The at least one sample holder 14 and/or at least one measurement device 16 can be on-board the rotor body. By “on-board,” the at least one sample holder and/or the at least one measurement device is/are a part of the centrifuge rotor and is/are physically present in and/or on the rotor body.

The rotor body 12 can have any suitable shape and dimensions. For example, the shape and dimensions of the rotor body 12 can depend on the type of material to be tested, the number of samples accommodated by the rotor body 12, the type of measurement device to be accommodated by the rotor body 12, and the specific centrifuge device with which the centrifuge rotor 10 is to be used. For example, the rotor body 12 can have a generally circular or cylindrical shape. For example, the rotor body 12 can have a diameter of from about 5 cm to about 50 cm, for example, from about 10 cm to about 30 cm. For example, the weight of the rotor body 12 can be substantially evenly distributed so as to reduce or prevent unbalanced forces caused by rotation. The rotor body 12 can be formed from any suitable material including, for example, a metal or carbon.

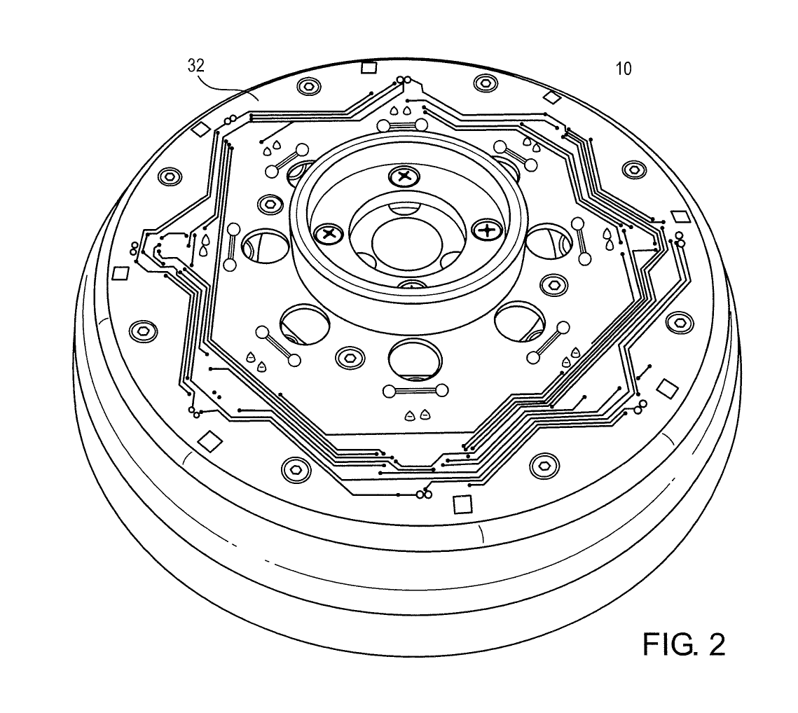

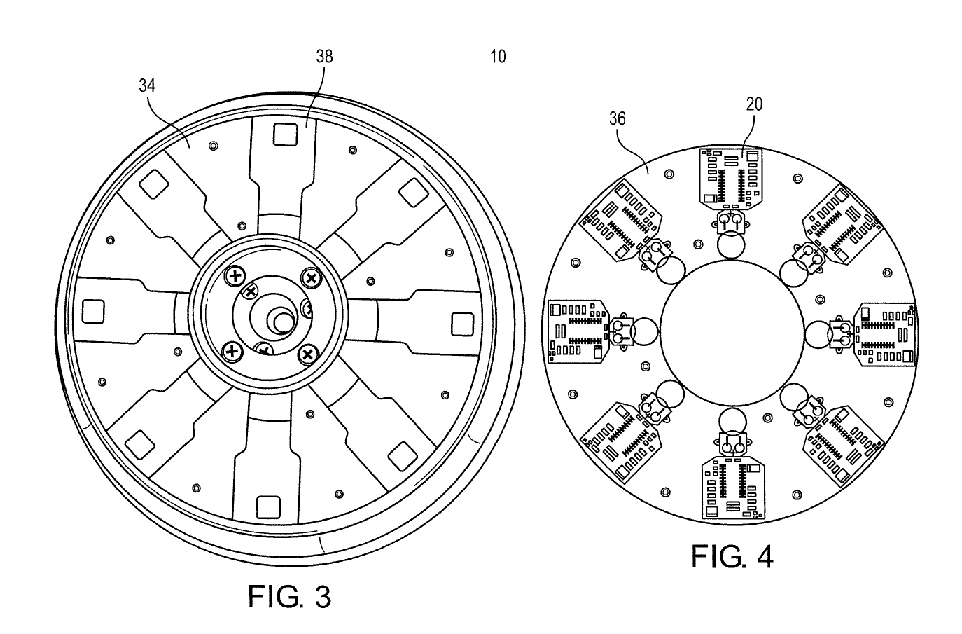

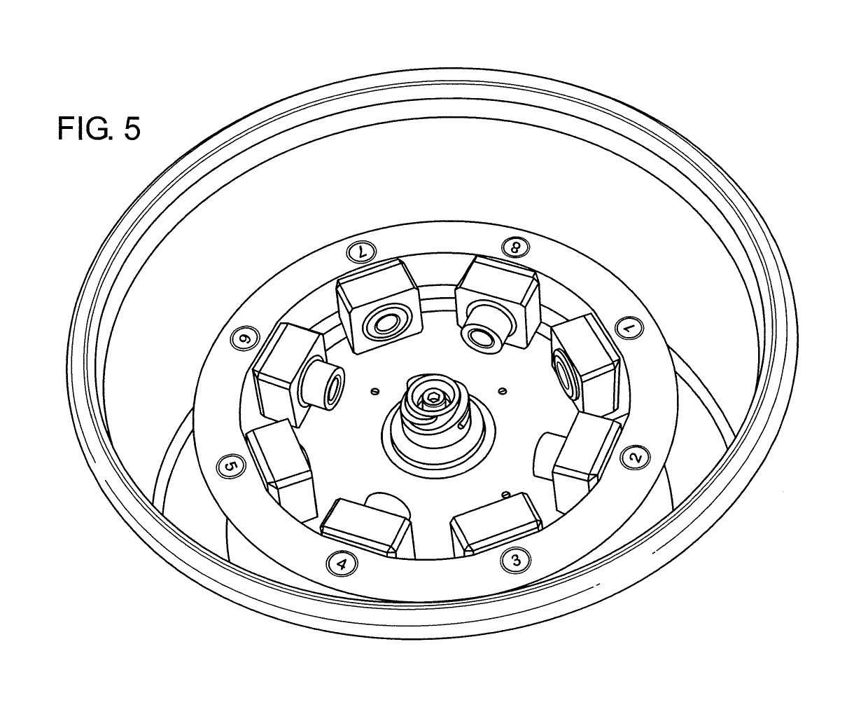

For example, the rotor body 12 can have an upper side 30 for accommodating the sample holders 14. As shown in FIG. 2, the rotor body 12 can have a lower side 32 for accommodating the at least one measurement device 20. In an exemplary embodiment as shown in FIGS. 3 and 4, the rotor body 12 can include a main body 34 and a back plate 36. For example, the at least one measurement device 20 can be mounted to the back plate 36, and corresponding cavities 38 can be disposed in the main body 34 to accommodate the measurement devices 20 when the back plate 36 is mounted onto the main body 34.

The centrifuge rotor 10 can have at least one on-board sample holder 14 for holding a sample 16. Each sample holder 14 can securely hold a sample 16 during rotation of the centrifuge rotor 10. Each sample holder 14 can be fixed in position with respect to the rotor body 12. The sample holder 14 is a part of the centrifuge rotor 10, and rotates as the centrifuge rotor 10 rotates, for example, during centrifugation. The at least one sample holder 14 can rotate about the axis of rotation during rotation of the rotor body 12.

Any suitable structure of the sample holder 14 can be employed which enables the sample 16 to be securely held and which facilitates the placement of a sample 16 into the sample holder 14 and the removal of the sample 16 from the sample holder 14. The structure of the sample holder 14 can depend on, for example, the particular weight, size, shape and characteristic of the sample to be analyzed. The sample holder 14 can be dimensioned so as to securely hold the sample 16 during rotation of the centrifuge rotor 10.

For example, the at least one sample holder 14 can be attached to the rotor body 12, can be integral with the rotor body 12, or can contain structure that is both integrated with the rotor body 12 and attached to the rotor body 12. For example, the at least one sample holder 14 can be a part that is removable from the rotor body 12 to facilitate loading of the sample, and attachable to the rotor body 12 to ensure secure attachment during rotation. For example, the at least one sample holder 14 can include an opening formed in the rotor body 12 for receiving a sample.

The centrifuge rotor can have any suitable number of sample holders. For example, the centrifuge rotor can have at least one sample holder, for example, at least 2 sample holders, for example, at least 4 sample holders. For example, the centrifuge rotor can have from 1 to 64 sample holders, for example, 8 to 32 sample holders, for example, 8 or 16 sample holders. For example, an even number of sample holders can be used, for example, to mitigate or avoid unbalanced rotation. For example, each of the sample holders of the centrifugal rotor can be identical to each other. For example, the sample holders can be positioned in a substantially radially symmetric arrangement about the axis of rotation of the centrifuge rotor.

The centrifuge rotor can be used to measure the characteristic of any sample which has a characteristic that is measurable during rotation in a centrifuge. For example, the sample or a material contained by the sample has a characteristic such as a property or a status that is measurable during rotation. For example, the sample can be of a material or contain a material having a property or status that is susceptible to change when subjected to a centrifugal force.

As shown in FIG. 4, the centrifuge rotor 10 can have at least one on-board measurement device 20 for measuring a characteristic of the sample during rotation of the rotor. The at least one on-board measurement device 20 can be positioned with respect to the sample holder 14 such that when a sample 16 is present in the sample holder 14, the measurement device 20 is capable of measuring a property or status of the sample 16. For example, the measurement device 20 can be attached to the sample holder 14. The at least one measurement device can be fixed in position with respect to the rotor body.

By employing at least one measurement device on the centrifuge rotor, for example, changes occurring in the sample can be measured continuously. For example, by employing at least one measurement device on the centrifuge rotor, user error occurring concerning the arrangement of the sample in relation to the measurement device can be mitigated or avoided. For example, measurement can be performed at a given temperature or atmosphere, which can be maintained by the centrifuge in the centrifuge vessel containing the rotor with the sample. The measurement device 20 can provide an output containing data which can further be stored and/or processed.

The at least one measurement device 20 constitutes a part of the centrifuge rotor 10 and rotates with the centrifuge rotor 10 during centrifugation. The at least one measurement device 20 can be securely attached to the rotor body 12 so as to prevent detachment during rotation of the centrifuge rotor 10. The at least one measurement device 20 can be stationary with respect to a corresponding sample holder 14 even during rotation, and rotate about the axis of rotation during rotation of the rotor body 12. The at least one measurement device 20, the at least one sample holder 14 and the at least one sample 16 can all rotate, for example, at the same rpm rate, when the centrifuge rotor 10 rotates during centrifugation. Thus, for example, the measurement of the sample behavior during centrifugation can be conducted entirely with on-board components that are present as part of the centrifuge rotor 10.

The centrifuge rotor can have any suitable number of measurement devices. For example, the centrifuge rotor can have at least 1 measurement device, for example, at least 2 measurement devices, for example, at least 4 measurement devices. For example, the centrifuge rotor can have from 1 to 64 measurement devices, for example, 8 to 32 measurement devices, for example, 8 or 16 measurement devices. For example, an even number of measurement devices can be used, for example, to mitigate or avoid unbalanced rotation. For example, the number of measurement devices can correspond to the number of sample holders. For example, each of the measurement devices of the centrifugal rotor can be identical to each other. For example, the measurement devices can be positioned in a substantially radially symmetric arrangement about the axis of rotation of the centrifuge rotor. For example, each measurement device can be arranged such that the lengthwise dimension thereof is substantially parallel to the radial direction of the rotor and at any angle with regard to the rotating plane of the rotor.

In an exemplary embodiment, each measurement device corresponds to one and only one sample holder, and each measurement device is capable of taking a measurement of one and only one sample held in the corresponding sample holder.

Any suitable measurement device for measuring a characteristic of the sample that can change as a result of being subjected to centrifugal force can be employed. The measurement device can measure, for example, a property or a status of the sample or a material contained in the sample. For example, the change to the characteristic can be caused by static or dynamic forces applied by centrifugation. For example, the at least one measurement device can measure a location, a concentration, a color, a temperature and/or a pressure of the sample itself or a material contained in the sample. The at least one measurement device can provide vector data (for example, quantities that are described by both a magnitude and a direction) or scalar data (quantities that are described by a magnitude alone). For example, the at least one measurement device can measure characteristics of a sample of a liquid, a solid, a solid/liquid mixture, a dispersion or an emulsion. The measurement device can measure, for example, the degree or strength of adhesion between two materials, the yield stress of a non-Newtonian material, the elongation of a body or material, the hardness of a material, the flow of a material, and/or the number of particles detaching from a surface. For example, the measurement device can detect an event such as, for example, the separation of two materials previously adhered together.

In an exemplary embodiment, the at least one measurement device can measure a characteristic of a sample containing a liquid, dispersion or emulsion. The material that is measured can be any material that is alterable by centrifugal force. The material can include, for example, a biological material such as blood, an ink dispersion, or a liquid or semi-liquid food product or cosmetic. The sample can include, for example, a container such as a measurement cell such as a cuvette or the like, which contains the material to be measured. In an exemplary embodiment, the measurement cell for containing the material to be measured can have a substantially rectangular cross-sectional profile.

For example, the at least one measurement device can include a light source arranged to introduce light to the sample. The light source can be a light source that produces monochromatic parallel radiation such as, for example, a multiwavelength point source. For example, the light source can be structured and arranged such that substantially the entire sample is irradiated with light from the light source. The light source can be arranged at any suitable distance from the sample when the sample is placed in the sample holder such as, for example, from 1 μm to 5 cm, for example, from 10 μm to 1 mm.

The measurement device can also include a light sensor for measuring for measuring transmitted and/or scattered light from the sample. For example, the light sensor can include at least one CCD line, for example, a plurality of CCD lines (for example, a CCD array). The light sensor can be arranged at any suitable distance from the sample when the sample is placed in the sample holder such as, for example, from 1 μm to 5 cm, for example, from 10 μm to 1 mm.

In an exemplary embodiment, the light source, light sensor, sample holder and sample (such as a measurement cell) can be arranged in any suitable manner that enables a measurement to be taken during centrifugation. For example, each of the light source and light sensor can independently be arranged in the plane of the rotor body or out of the plane of the rotor body. For example, the light source and light sensor can be arranged at opposite sides of the sample holder, such that when light from the light source is radiated toward the sample, light transmitted through the sample and/or light scattered by the sample can be detected by the light sensor. For example, each of the light source and light sensor can be independently arranged above and/or below the sample holder. The measurement device can include at least one reflective surface such as a mirror in communication with either or both of the light source and the light sensor. For example, use of a reflective surface can provide flexibility in the placement of the light source and light sensor with respect to the sample holder. For example, each of the light source and light sensor can be independently arranged at any suitable angle with respect to the sample and sample holder. For example, the light source and light sensor can be arranged such that the lengthwise dimension of each of the light source and light sensor is oriented substantially parallel to the sample when placed in the sample holder. For example, the light source and light sensor can be arranged such that the lengthwise dimension of each of the light source and light sensor is oriented substantially parallel to the radius of the rotor body.

The at least one measurement device can simultaneously measure a characteristic at one or more points of the sample, for example, over a partial length of sample, for example, the entire length of the sample. In an exemplary embodiment, the measurement device can simultaneously measure a characteristic over an entire length of the sample, for example, when the measurement device includes a light source and a CCD line or CCD array.

For example, the sample holder and light source can be arranged such that when the measurement cell is placed in the sample holder, the light source at least partially irradiates the sample, for example, radiates the entire sample. For example, the sample holder and light sensor can be arranged such that when the measurement cell is placed in the sample holder, the light sensor extends along at least a part of the length of the sample (such as a measurement cell), for example extends along the entire length of the sample. For example, each of the light source, measurement cell and light sensor can have a length of from about 1 cm to about 5 cm, for example, from about 0.1 mm to about 5 mm.

In an exemplary embodiment, at least one aspect of systems and methods for characterizing a sample described in U.S. Pat. No. 8,265,882, the entire contents of which are hereby incorporated by reference, can be adapted for use in an exemplary centrifuge rotor or a method involving the use of such rotor. For example, properties of the dispersion can be calculated in any suitable manner such as, for example, in accordance with techniques described in U.S. Pat. No. 8,265,882, the entire contents of which are hereby incorporated by reference.

In an exemplary embodiment, the measurement device can measure the degree or strength of adhesion between materials, for example, the partial or complete separation of materials previously adhered together. For example, the breakage of a joint or composite material (for example, the delamination of a coating) can be measured, for example, as described in U.S. Pat. No. 7,707,895, the entire contents of which are herein incorporated by reference.

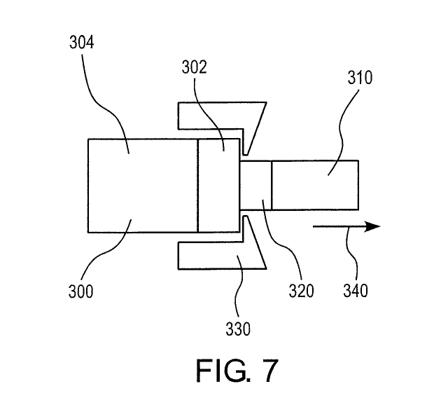

For example, as shown in FIG. 7, a sample 300 can be provided having a first material 302 and a second material 304 adhered to each other. The adhesion between the first material 302 and the second material 304 can be tested. For example, the first and second materials 302 and 304 can be a coating 302 applied to a substrate 304. A weight 310 (for example, a test stamp) can be attached to the first material 302. During rotation, a centrifugal force can be directed towards a cylindrical internal wall of the rotor as a pulling force on the connections between the weight 310 and the first material 302 attached to the weight 310 on one hand, and between the first material 302 and the second material 304 on the other hand. Because the strength of adhesion between the first material 302 and the second material 304 is to be tested, it can be ensured (for example, by use of adhesive 320) that the connection between the weight 310 and the first material 302 resists higher pulling forces than the connection between the first material 302 and second material 304. The weight 310 can serve for the formation of sufficient centrifugal force when the first material 302 alone does not have sufficient mass to produce the pulling force necessary for its detachment. The sample can be held by a sample holder 330 of the centrifuge rotor. The sample holder 330 can be structured such that centrifugal force is directed towards a cylindrical internal wall of the rotor as a pulling force on the connection between the first material 302 and the second material 304.

For example, at the moment of failure when the first material 302 separates from the second material 304, the weight 310 (for example, a test stamp) moves in the direction of the rotor outer wall (denoted by arrow 340) and can activate a sensor (not shown), which can signal the time of failure. Based on various parameters of the test including, for example, the rpm and dimensions of the centrifuge rotor, failure time, and the mass of the test stamp, the force of failure (for example, rupture) can be calculated.

In an exemplary embodiment, at least one aspect of systems and methods described in U.S. Pat. No. 7,707,895, the entire contents of which are hereby incorporated by reference, can be adapted for use in an exemplary centrifuge rotor or a method involving the use of such rotor. For example, the structure for holding the first and second adhered materials in the rotor as described in U.S. Pat. No. 7,707,895, can be employed.

In an exemplary embodiment, the centrifuge rotor can include at least one on-board wireless transmitter for transmitting measurement data obtained by the measurement device. The on-board wireless transmitter can be in and/or on the rotor body. For example, the at least one wireless transmitter can be in communication with at least one wireless receiver that is not on-board the centrifuge rotor. The at least one wireless transmitter can transmit measurement data information to the at least one wireless receiver. The wireless receiver can be located in any suitable location such, as for example, within a centrifuge device enclosure or outside of a centrifuge device enclosure. For example, the wireless receiver unit can include a device for conducting data processing. The wireless receiver unit can send the data, such as processed or unprocessed data, by wire or wireless means to a device for conducting further analysis such as, for example, a computer.

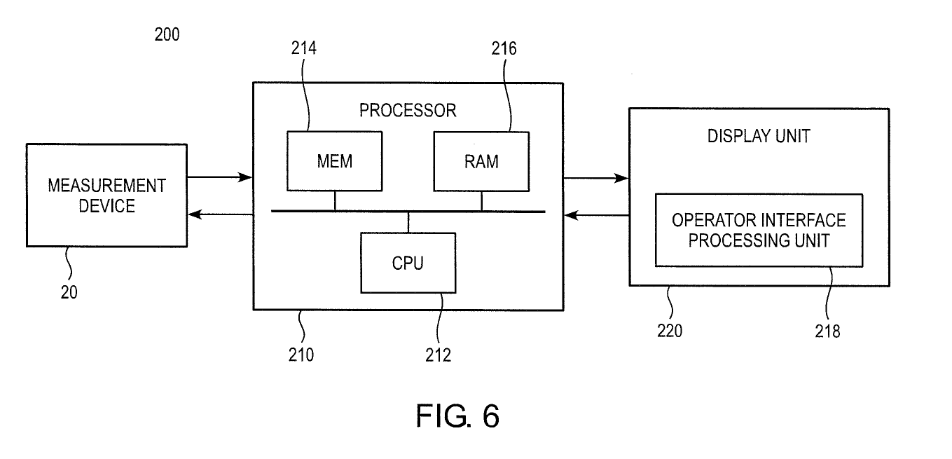

In an exemplary embodiment, the centrifuge rotor can include or be in communication with an on-board system for storing and/or processing the measurement data provided by the at least one measurement device 20. For example, the on-board system can also control the measurement device 20. In an exemplary embodiment shown in FIG. 6, the centrifuge rotor 12 can include a processor 210. The processor unit 210 can include a computer processor 212 (for example, a general-purpose processor such as an Intel® Core®, Pentium® or Celeron® processor or an AMD® Phenom®, Athlon® or Opteron® processor, or an application specific processor such as an application-specific integrated circuit (ASIC)) that is configured to control the operations of the centrifuge rotor including the measurement device 20. In the example of FIG. 6, the processor unit 210 is illustrated as including a non-transitory, non-volatile memory (MEM) 214 on which a computer program and/or computer-readable instructions is/are tangibly recorded. The processor (CPU) 212 can be configured to execute the program and/or instructions recorded on the memory 214 to carry out the operations and functions of the centrifuge rotor as described herein such as, for example, the control of the measurement device, the storing of measurement data and/or the processing of measurement data.

For example, use of a light source sensor system, for example, aligned to be parallel to the sample length, can measure and record deformation of a sample (such as, for example, elongation and/or thickening of the stressed sample) as a result of being subjected to centrifugal force. For example, such a measurement device can measure a gradual elongation of the sample due to centrifugal force. For example, a light source sensor system oriented to be perpendicular to, or at any other suitable angle to, the radial force can be employed to measure a decreasing cross-section due to elongation. For example, shortening in a length direction and thickening in a width direction (for example, cross-section) can be measured. For example, a sensor system can be placed at a top end of the material to be deformed by centrifugal force.

The processor (CPU) 212 can also instruct the MEM 214 to record therein measurements data obtained from the measurement device. In an exemplary embodiment where the measurement device includes a light source and light sensor, the processor (CPU) 212 can instruct the MEM 214 to record therein light transmission and/or light scattering data, for example, simultaneously over the entire length of the sample. In an exemplary embodiment where the measurement device measures the degree or strength of adhesion between materials, the processor (CPU) 212 can instruct the MEM 214 to record therein data concerning the adhesion failure of the sample.

In addition, the MEM 214 can have stored therein algorithms, look-up tables etc. for processing the measurement data received from the measurement device. For example, the MEM 214 can have stored therein algorithms, look-up tables and/or other information for processing the measurement data. For example, the MEM 214 can have stored therein a standard operating procedure for the manner in which measuring device operates. For example, the system can adjust at least one setting of a component of the measuring device prior to and/or during centrifugation. For example, the intensity of light emitted by the light source and/or the sensitivity of the light sensor can be adjusted before and/or during centrifugation depending on, for example, the properties of the sample and/or changes to the sample occurring during centrifugation.

The processor unit 210 can include a working memory such as a random access memory (RAM) 216 to utilize while performing its functions. In an exemplary embodiment, the RAM 216, MEM 214 and processor 212 are all provided on-board the centrifuge rotor, for example, housed in the rotor body. In an exemplary embodiment, the processor 212 can be provided on-board the centrifuge rotor, and the RAM 216 and MEM 214 can be provided separately from the processor 212, for example, in a different physical unit from the processor 212. The MEM 214 can be any type of non-volatile memory such as a read only memory (ROM), flash memory, optical memory, etc. The processor unit 210 can be in communication with a computer system that is external from the centrifuge rotor.

As shown in FIG. 6, operator interface processing unit 218 and display unit 220 can be provided. Each of the operator interface processing unit 218 and display unit 220 independently can be located either on-board the centrifuge rotor or separate from the centrifuge rotor. The operator interface processing unit 218 can be configured to display user-selectable operation instructions and any other information for the operation of the centrifuge rotor. The display unit 220 can be configured to display measurement results and enable control of the processor unit 210 and the centrifuge rotor. In the example of FIG. 6, the operator interface processing unit 218 is illustrated as being comprised in the display unit 220. For example, the operator interface processing unit 218 could be a touch-screen display in which a user can enter input commands via the display unit 220. However, it is conceived that the operator interface processing unit 218 may be provided separate from the display unit 220 and include physical input means such as keys, trackpads, buttons, etc.

The measurement device 20 and/or on-board system 200 can include an analog to digital converter for converting analog information of the measurement device to digital information. For example, an output from a light sensor of a measurement device can be stored directly or after being converted to digital format by an analog to digital converter. In an exemplary embodiment, the centrifuge rotor can contain an analog-to-digital converter for converting measurement data.

In an exemplary embodiment, the on-board system 200 for storing and/or processing the measurement data, which is contained by the centrifuge rotor and forms a part of the centrifuge rotor, is distributed within the centrifuge rotor so as to promote rotation of the centrifuge rotor. For example, the components of the on-board system can be substantially evenly distributed within the centrifuge rotor. For example, the components can be arranged so as to distribute the mass of the components in a radially symmetrical manner. The at least one measurement device and the on-board system can be formed of components which are capable of withstanding the forces applied thereto during centrifugation. For example, at least one component can be covered with a coating which provides mechanical stability.

In an exemplary embodiment, the centrifuge rotor can include at least one power source on-board the centrifuge rotor. For example, the power source can be a battery such as a rechargeable battery. Power can be provided discontinuously (for example, by a battery) or continuously. For example, the power source can provide power during centrifugation by use of dynamo principles, for example, by use of an electrical generator. The power source can be used to provide power to any component of the centrifuge rotor that consumes power including, for example, the at least one measurement device and/or on-board system for storing and/or processing the measurement data. The at least one measurement device and/or on-board system for storing and/or processing the measurement data can be connected to the power source in any suitable manner.

The centrifuge rotor can have an engagement device, for example, at the center of the centrifuge rotor, for attaching the centrifuge rotor to the centrifuge machine, for example, a shaft of a centrifuge machine. The engagement device can enable the centrifuge rotor to be securely attached to the centrifuge machine so as to prevent unintended detachment of the centrifuge rotor during rotation.

According to an exemplary aspect, disclosed is a centrifuge device including a centrifuge rotor. Any suitable centrifuge machine can be employed with the exemplary centrifuge rotor. For example, an exemplary centrifuge machine is available from LUM GmbH located in Berlin, Germany and available under the tradename LUMiFuge®. For example, the centrifuge device can include a housing, an exemplary centrifuge rotor, an engagement part for removably attaching the centrifuge rotor to the motor, and a motor for rotating the centrifuge rotor.

According to an exemplary aspect, a method of measuring a characteristic of a sample by centrifugation is provided. The method can include: providing an exemplary centrifuge device including an exemplary centrifuge rotor; attaching at least one sample to the centrifuge rotor with the at least one sample holder; rotating the centrifuge rotor; and conducting at least one measurement with the at least one measurement device during rotation of the rotor. The rotor can be rotated at any suitable speed, for example, from 50 to 100,000 rpm, for example, from 100 to 15,000 rpm, for example, from 200 to 4,000 rpm.

Various exemplary applications are described below. For example, the sample can include a metal, glass, ceramic, polymer or adhesive, and the characteristic to be measured can include optimum composite strength. For example, the sample can include materials that have a treated surface, such as a coated, cleaned, activated or modified surface, and subjecting the sample to a centrifugal force can measure the efficacy or effect of the surface treatment, for example, on adhesion properties. For example, the sample can include metallized glass and polymers or multilayered systems, and the characteristic to be measured can include layer and interlayer adhesion and peel resistance. For example, the sample can include a paint or varnish, and the characteristic to be measured can include adhesion or cross-cut test performance. For example, the sample can include copper or epoxy adhesive with spacers, and optimum adhesion layer thicknesses can be ascertained. For example, the sample can include a thermally sprayed coating, and the characteristic to be measured can include adhesive strength. For example, use of an exemplary centrifuge rotor can enable detailed observation and measurement of failure patterns and fracture areas of samples. For example, use of an exemplary centrifuge rotor can enable detailed observation and measurement of tensile strength of materials. For example, the centrifuge rotor can be employed for the measurement of a characteristic such as bond strength of materials employed in the building industry, lightweight construction, the automotive and aerospace industry, electronics and optics and maintenance and repair. For example, the centrifuge can be employed for the measurement of materials employed in optical and electrical functions, corrosion protection, decoration and wettability barriers and hermetisation, and scratch and wear resistance.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A centrifuge rotor for measuring a characteristic of a sample subjected to centrifugation, the centrifuge rotor comprising:
a rotor body;
at least one sample holder for holding a sample; and
at least one on-board measurement device for measuring a characteristic of the sample held in the at least one sample holder during rotation of the rotor.

2. The centrifuge rotor according to claim 1, wherein the at least one sample holder is fixed in position with respect to the rotor body, and wherein the at least one measurement device is fixed in position with respect to the rotor body.

3. The centrifuge rotor according to claim 1, wherein the centrifuge rotor contains a plurality of sample holders and a plurality of measurement devices.

4. The centrifuge rotor according to claim 3, wherein each measurement device corresponds to one and only one sample holder, wherein each measurement device is capable of taking a measurement of one and only one sample held in the corresponding sample holder.

5. The centrifuge rotor according to claim 4, wherein a distance between each measurement device and its corresponding sample holder remains constant during rotation of the rotor.

6. The centrifuge rotor according to claim 3, wherein the plurality of sample holders are positioned in a substantially radially symmetric arrangement about an axis of rotation of the centrifuge rotor.

7. The centrifuge rotor according to claim 3, wherein the plurality of measurement devices are positioned in a substantially radially symmetric arrangement about an axis of rotation of the centrifuge rotor.

8. The centrifuge rotor according to claim 1, wherein the centrifuge rotor comprises 8 to 32 measurement devices.

9. The centrifuge rotor according to claim 1, wherein the at least one measurement device comprises a light source and a light sensor.

10. The centrifuge rotor according to claim 9, wherein the light source emits parallel radiation.

11. The centrifuge rotor according to claim 1, wherein the measurement device comprises a device for measuring a separation of at least two materials adhered to each other.

12. The centrifuge rotor according to claim 1, wherein the measurement device comprises a device for measuring a deformation of a sample as a result of being subjected to a centrifugal force.

13. The centrifuge rotor according to claim 1, further comprising an on-board power source.

14. The centrifuge rotor according to claim 1, further comprising at least one on-board wireless transmitter for transmitting measurement data measured by the measurement device to a wireless receiver.

15. The centrifuge rotor according to claim 1, further comprising at least one on-board system for storing and/or processing measurement data outputted from the measurement device.

16. The centrifuge rotor according to claim 15, wherein the centrifuge rotor comprises at least 2 sample holders and at least 2 measurement devices, and wherein each of the measurement devices is arranged to provide measurement data to the at least one on-board system for storing and/or processing measurement data outputted from the measurement device.

17. The centrifuge rotor according to claim 1, wherein the at least one measurement device is in a fixed position with respect to the at least one sample holder.

18. A method of measuring a characteristic of a sample by centrifugation, the method comprising:
providing the centrifuge rotor according to claim 1;
attaching at least one sample to the centrifuge rotor with the at least one sample holder;
rotating the centrifuge rotor; and
conducting at least one measurement with the at least one measurement device during rotation of the rotor.

19. A centrifuge device for measuring a characteristic of a sample by centrifugation, the centrifuge device comprising:
the centrifuge rotor according to claim 1;
a housing; and
a motor for rotating the centrifuge rotor.
